(19) United States
(12) Patent Application Publication
(10) Pub. No.: US 2009/0259436 A1
(43) Pub. Date: Oct. 15, 2009

(54) METHODS AND APPARATUS TO DETERMINE BOARD EXPOSURE LEVELS

(76) Inventor: Peter Campbell Doe, Ridgewood, NJ (US)

Correspondence Address: Hanley, Flight & Zimmerman, LLC, 150 S. Wacker Dr. Suite 2100, Chicago, IL, 60606, US

(21) Appl. No.: 12/164,842

(22) Filed: Jun. 30, 2008

Related U.S. Application Data
(60) Provisional application No. 61/044,359, filed on Apr. 11, 2008.

(51) Int. Cl. G06F 17/18

(52) U.S. Cl. 702/181

(57) ABSTRACT

Methods and apparatus to determine board exposure levels are disclosed herein. In a disclosed example method, exposure levels associated with a plurality of media boards are obtained and a plurality of probability distributions indicative of probable exposure levels for the plurality of media boards are determined. The example method also involves selecting one of the plurality of probability distributions corresponding to an expected distribution and smoothing the selected probability distribution. Each of the plurality of media boards is then credited with a respective processed exposure level of the smoothed probability distribution.

### RELATED APPLICATIONS

This Patent claims the benefit of U.S. Provisional Patent Application No. 61/044,359, filed on Apr. 11, 2008, which is hereby incorporated herein by reference in its entirety.

### FIELD OF THE DISCLOSURE

The present disclosure relates generally to survey media exposures and, more particularly, to methods and apparatus to determine board exposure levels.

### BACKGROUND

Product manufacturers, service providers, and advertisers are often interested in consumer exposure to advertisements such as billboards, signs, and/or other public advertising. Known techniques for monitoring consumer exposure to advertisements include conducting surveys, counting consumers, and/or quantifying amounts of traffic that pass by advertisements. To develop such surveys and to correlate passerby traffic with advertisement content, the accuracy of the recorded information about the advertisements of interest directly affects the meaningfulness of the exposure study results.

In some instances, a media research company can recruit panel members that are surveyed or tracked to determine billboards or other signage to which each panel was exposed. For example, if a panel member indicates that he or she was driving north on a particular stretch of road, it may be concluded that the panel member was exposed to all billboards facing south along that stretch of road. The survey results or location tracking information can then be processed to determine the number of exposure instances for each billboard or signage that is part of a media research study. The panel member exposures can then be used to infer the number of exposures to the generic public for each billboard or signage. These exposure numbers can be used by product manufacturers, service providers, and advertisers to better market their products.

### BRIEF DESCRIPTION OF THE DRAWINGS

FIG. 1 illustrates an example geographic area including a plurality of boards.

FIG. 2 is an example site types data structure that stores names of different example site types for which board exposure measurements can be processed as described herein.

FIG. 3 is an example data structure that stores measured exposure level values in association with respective board identifiers and board characteristics of the plurality of boards of FIG. 1.

FIG. 4 is an example area data structure that stores names of different areas or different area types of a geographical area to indicate the geographical location within which boards are located.

FIG. 5 is an example board exposure performance table comparatively displaying standard error values and confidence intervals between pre-processed board exposure level values and post-processed board exposure level values.

FIG. 6 is a block diagram of an example apparatus that may be used to determine individual board exposure levels.

FIG. 7 is a flow diagram representative of example machine readable instructions that can be executed to implement the example apparatus of FIG. 6 to determine individual board exposure levels.

FIG. 8 is a flow diagram representative of example machine readable instructions that can be executed to adjust exposure levels of boards having been erroneously associated with having zero exposures to panel members.

FIG. 9 is a flow diagram representative of example machine readable instructions that can be executed to adjust exposure levels of boards having been genuinely or correctly associated with having zero exposures to panel members.

FIGS. 10A and 10B depict a flow diagram representative of example machine readable instructions that can be executed to determine a board exposure distribution using a Bayesian smoothing technique.

FIG. 11 is a block diagram of an example processor system that may be used to execute the machine readable instructions of FIGS. 7-9, 10A, and/or 10B to implement the example apparatus of FIG. 6.

### DETAILED DESCRIPTION

Although the following discloses example methods, apparatus, and systems including, among other components, software executed on hardware, it should be noted that such methods, apparatus, and systems are merely illustrative and should not be considered as limiting. For example, it is contemplated that any or all of these hardware and software components could be embodied exclusively in hardware, exclusively in software, exclusively in software or in any combination of hardware, firmware, and/or software. Accordingly, while the following describes example methods, apparatus, and systems, the examples provided are not the only way to implement such methods, apparatus, and systems.

The example methods and apparatus described herein may be used to determine board and/or other signage exposure levels (referred to herein as “board exposure levels”) by processing measured board exposure levels to reduce inaccurate or erroneous exposure level measurements and, thus, increase the reliability of those board exposure level measurements. A board may be a billboard, a poster, a mural, or any other signage used to display information such as, for example, advertisements, retail establishment names, etc. Product manufacturers, service providers, and/or advertisers are often interested in the exposure performance of their advertisements. Exposure performance is based on the number of times that advertisement boards are exposed to persons (or respondents) during a given time period. An exposure to a board occurs when a person passes near the board and is within a distance of the board that enables the user to view the board.

To measure exposure levels for a board, a representative panel of people (e.g., a sample of people) in a particular geographic area is selected for study. Measuring exposures to boards can be done in a number of ways. For example, board exposure can be measured by surveying each person in the representative panel to ask the location(s) that they have visited during a particular time period and their travel routes during that time period. Additionally or alternatively, the persons in the representative panel can be asked to confirm which boards they have seen. In some example implementations, exposure measurements can be collected using portable meters that are configured to collect location information indicative of paths of travel of the person(s) of the representative panel that wear or carry the meter(s). The portable meters may alternatively or additionally be configured to collect code-carrying signals emitted by transmitters mounted on or adjacent to the boards and identifying the corresponding board(s) so that the collected codes can subsequently be processed to determine the boards to which the people of the representative panel were exposed. Any other suitable method to measure exposure levels of boards may alternatively or additionally be used.

Measured board exposure levels can contain inaccurate or erroneous information caused by, for example, measurement techniques, inaccurate reference information used to measure the board exposures, and/or due to the activities or the people in the selected panels. For example, a board exposure level for a particular board may indicate zero exposure because none of the people in a particular representative panel were exposed to the board even though, in actuality, the board was exposed to many people of the general public. A board's exposure level may also indicate a zero exposure or an uncharacteristically low exposure level due to erroneous information stored to describe the board. For example, if descriptive information about a board stored in a board reference database used to measure exposure levels incorrectly indicates that the board is facing a southward direction along a one-way road on which traffic moves only in a northward direction, the exposure level for that board will be incorrectly recorded as zero exposure.

Advertisement campaigns involve using different advertisement boards (e.g., billboards, posters, murals, etc.), and each board, when measured for exposure based on a selected respondent sample (i.e., a group of people selected for study), can have a fairly large degree of exposure variability. In some instances, on average, a board is typically passed by less than 1% of the selected respondent sample, and the geographical dispersion of board sites and the respondent sample means that some board sites have no respondent passage while others have a high frequency of respondent passage. For instance, a board site having had one person going past it 81 times will have a very high exposure level, but to only this one person. If this board were selected in a campaign, the campaign's demographic profile would be skewed to this respondent's demographics.

The example methods and apparatus described herein can be used to substantially reduce or eliminate inaccuracies in board exposure level measurement data used to measure exposure to boards such as billboards, posters, murals, etc. In particular, the example methods and apparatus described herein use data smoothing processes to ensure that statistical outlier exposure levels that are erroneously too low or too high are adjusted to more credible and/or accurate values. The example methods and apparatus can be configured to identify boards associated with excessively high or statistically outlying exposure frequencies, which can be evidence of exposure measurement errors. For each board having an inaccurately high exposure frequency, its exposure level is reduced to a more credible level. The example methods and apparatus can also be configured to identify boards credited with zero exposures (e.g., no exposures to respondents of a representative panel) and that are located in areas with other boards tagged as having had some exposures. For each board identified as having zero exposures, its exposure level is adjusted based on average exposure levels of boards having had some exposure and located or situated within the same area as that board or characteristically similar areas (e.g., high-traffic areas, low-traffic areas, etc.). The adjusted exposure levels are then processed using a smoothing technique to determine exposure levels that are relatively more accurate and representative of exposure levels of boards to the general public. The smoothed exposure levels can then be used to credit respective media boards with more credible and accurate levels.

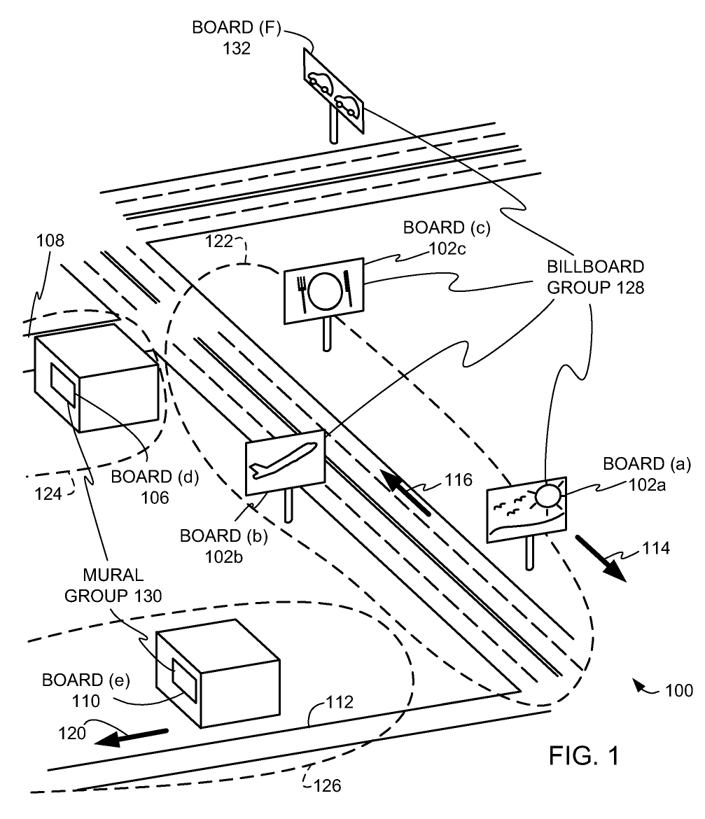

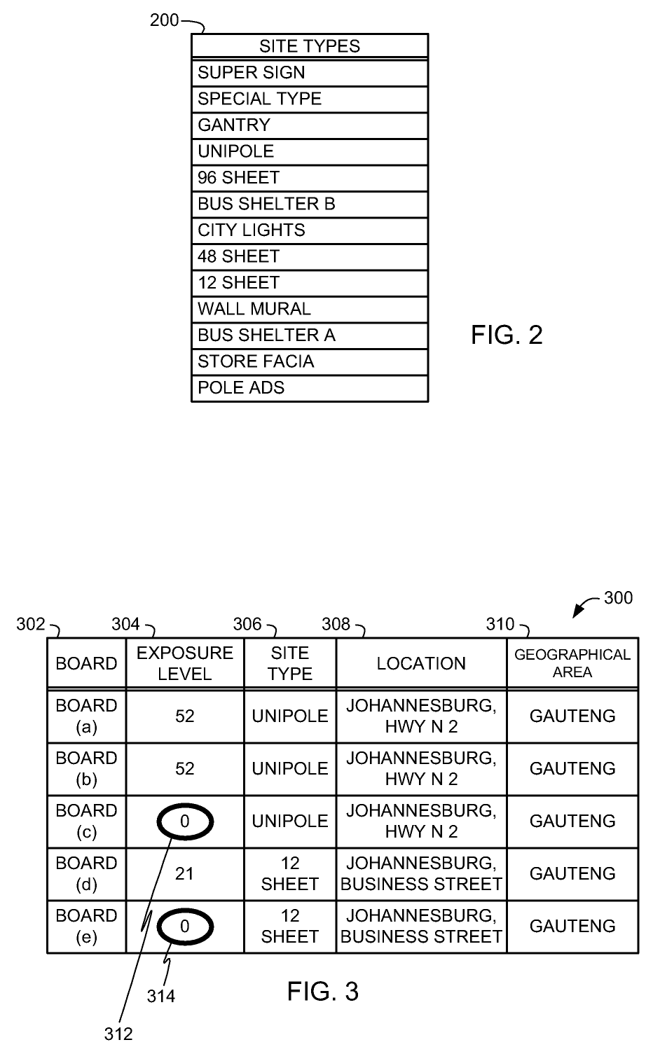

Turning to FIG. 1, an example geographic area 100 includes a plurality of advertisement boards 102a-c of the billboard type located along a high-traffic highway 104, an advertisement board (d) 106 of a mural type located on a low-traffic tributary road 108, and an advertisement board (e) 110 located on another low-traffic tributary road 112. Although the example geographic area 100 is shown as having billboard type boards and mural type boards, the example methods and apparatus describe herein can be used in connection with measuring exposure to any other types of boards. (Boards are also referred to herein as site types.) Referring to FIG. 2, an example site types data structure 200 includes names of different example site types for which exposure measurements can be processed as described herein. The example site types include a super sign type, a special type, a gantry type, a unipole type, a 96-sheet mural type, a bus shelter B type, a city lights type, a 48-sheet mural type, a 12-sheet mural type, a wall mural type, a bus shelter A type, a store facia type, and a pole ads type. Although not shown, the example methods and apparatus described herein can also be used in connection with other site types.

In the illustrated example, the advertisement boards 102a-c are facing toward a direction generally indicated by arrow 114. Thus, any person traveling (e.g., in a car) toward the advertisement boards 102a-c in a direction generally indicated by arrow 116 would be exposed to all of the advertisement boards 102a-c. The advertisement boards 106 and 110 are facing toward a direction generally indicated by arrow 120. Thus, people traveling in a direction opposite or substantially opposite the arrow 120 on the road 108 would be exposed to the advertisement board 106, and people traveling in a direction opposite or substantially opposite the arrow 120 on the road 112 would be exposed to the advertisement 110.

In the illustrated example, the advertisement boards 102a-c are grouped into a segment 122, the advertisement board (d) 106 is grouped into a segment 124, and the advertisement board (e) 110 is grouped into a segment 126. Each of the segments 122, 124, and 126 are used to determine whether any board exposure levels in that segment are considered to be excessively high. That is, a segment is formed of boards expected to have substantially similar exposure levels. If any board in that segment has markedly different exposure levels from the other boards in the segment, the exposure level of that board can be adjusted to coincide with the exposure levels of the other boards in that same segment. For example, in FIG. 1, the boards 102a-c are part of the segment 122 and are expected to have similar exposure levels because they are all located along the same highway 104 (i.e., along the same path of travel) and are all facing toward the same direction. In using the segment 122 to process the exposure levels of the boards 102a-c, if the board 102a has an exposure level that is inaccurately different from the exposure levels of the other boards 102b-c, the exposure level of the board 102a can be adjusted to be more similar to the exposure levels of the boards 102b-c. Such an adjustment can be done by capping or limiting a high exposure frequency and/or by averaging the total exposures of all the boards 102a-c as if the total exposures were spread equally among all the boards 102a-c.

The segments 122, 124, and 126 can also be used to compare board exposure levels across similar segments and adjust exposure levels, if necessary. For example, the segments 124 and 126 are of a similar type in that each is located along a respective low-traffic tributary road 108 and 112. Thus, the boards 106 and 110 are expected to have similar exposure levels. Using the example methods and apparatus described herein, the exposure levels of the boards 106 and 110 can be compared to one another because they belong to similar types of segments and can further be compared to exposure levels of other boards in similar segment types to determine whether any of the exposure levels are inaccurately different, which may be indicative of a measurement error. For any board having an inaccurately different exposure level, the exposure level of that board can be adjusted to coincide with the exposure levels of the other boards in similar segments.

Exposure level adjustments can also be made based on board types. For example, while billboard type boards may be perceivable by pedestrians, vehicle drivers, and vehicle passengers, bus shelter type boards may be more readily perceivable by pedestrians than drivers and passengers of automobiles. Therefore, if a segment (e.g., one of the segments 122, 124, and 126) includes billboard type boards and bus shelter type boards, the exposure levels of the bus shelter type boards can be compared with exposure levels of only other bus shelter type boards in other segments because bus shelter type boards are expected to have similar exposure levels to one another, but different exposure levels than those of billboard type boards.

In the illustrated example, the boards 102a-c, 106, and 110 are further grouped into respective geographical area groups 128 and 130. Geographical area groups are used to group boards based on different governmental and/or natural geographic demarcated areas (e.g., towns, cities, counties, provinces, states, territories, islands, etc.) to compare exposure levels between different boards within a same geographical area. Geographical area groups may be formed by grouping boards with other boards expected to have similar exposure levels and/or with other boards of a similar site type or board type. In the illustrated example, the billboard type boards 102a-c are grouped in the billboard group 128 along with a board (F) 132 because the boards 102a-c and 128 are of the same type. In addition, the mural type boards 106 and 110 are grouped in a mural group 130 because they are of the same type. Geographical area groups such as the groups 128 and 130 may be used in a similar manner as the segments 122, 124, and 126 to compare exposure levels of boards throughout a geographic area larger than segments to determine whether exposure levels of particular boards should be adjusted.

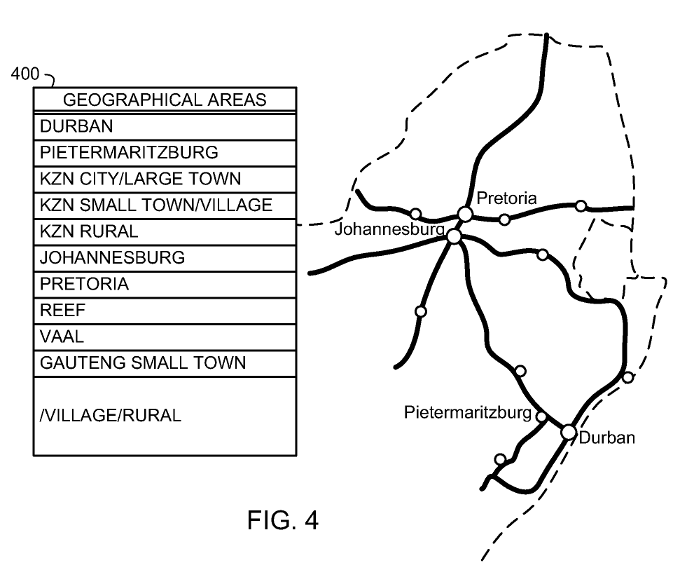

FIG. 3 is a data structure 300 to store measured exposure level values in association with respective board identifiers and board characteristics of the boards 102a-c, 106, and 110 of FIG. 1. In the illustrated example, the data structure 300 includes a board identifier column 302 to store unique board identifiers corresponding to respective ones of the boards 102a-c, 106, and 110 of FIG. 1. The data structure 300 also includes an exposure level column 304 to store exposure level values in association with respective ones of the board identifiers in the board identifier column 302. A site type column 306 is used to store site type (or board type) information descriptive of respective ones of the boards 102a-c, 106, and 110 corresponding to the board identifiers in the board identifier column 302.

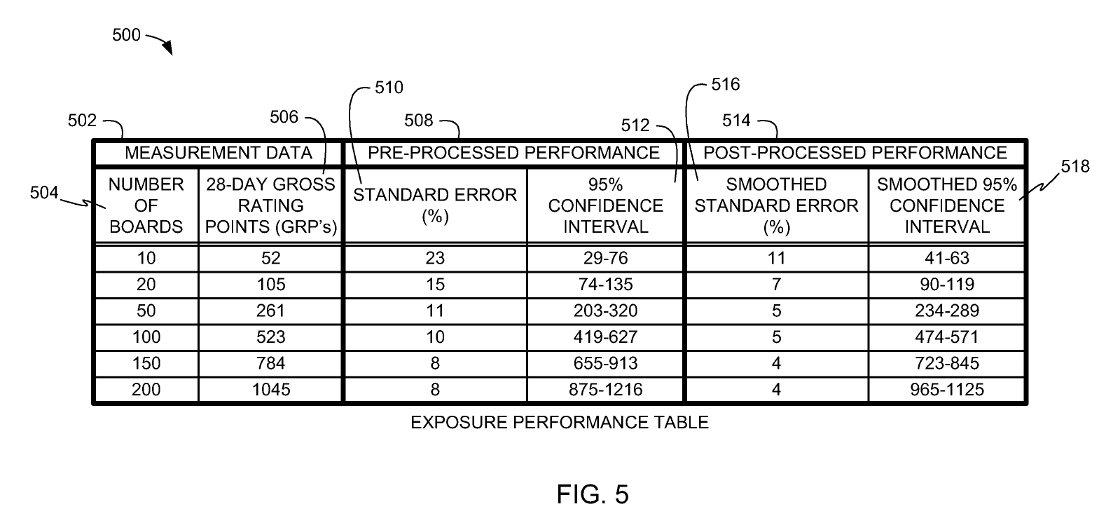

To store location information about boards, the data structure 300 is provided with a location column 308 and a geographical area column 310. The location column 308 is used to store segment-based location information (or segment identifiers) indicative of locations (or segments) of respective ones of the boards 102a-c, 106, and 110 that can be used to group the boards 102a-c, 106, and 110 into respective ones of the segments 122, 124, and 126. The geographical area column 310 is used to store relatively larger area location information (or area identifiers) indicative of the locations (or area groups) in which the boards 102a-c, 106, and 110 are located. The geographical area column 310 can be used to store geographical area identifiers associated with any suitable type of governmental and/or natural geographic demarcations including, for example, towns, cities, counties, provinces, states, territories, islands, etc. For example, referring to FIG. 4, an example area data structure 400 includes names of different areas or different area types of the country of South Africa that can be stored in the geographical area column 310 to indicate the geographical location within which boards are located. As shown in FIG. 4, the geographical areas can be identified by name (e.g., Durban, Pietermaritzburg, Johannesburg, Pretoria, Reef, and Vaal) or by type (e.g., city/large town, small town/village, rural, etc.). The geographical areas can be used to define geographical boundaries of geographical area groups of boards such as the geographical area groups 128 and 130 of FIG. 1.

In the illustrated example of FIG. 3, the exposure level column 304 includes two zero exposure level entries 312 and 314. The zero exposure level entry 312 indicates that the board (c) 102c was measured to have zero exposures to any person of a particular representative panel, and the zero exposure level entry 314 indicates that the board (e) 110 was measured to have zero exposures to any person of the representative panel. As discussed above, a zero exposure level value may be a genuine zero exposure level value or an erroneous zero exposure level value. A genuine zero exposure level value is one that accurately indicates that a corresponding board was not exposed to any of the people of a particular representative panel even though the board could have been exposed to other people of the general public that were not part of the representative panel. An erroneous zero exposure level is one resulting from an error in exposure measurement such as, for example, a measurement that was performed using board reference data that included an incorrect location or facing direction for the board, an anomaly in the data due to the panel makeup, behavior, etc. In any case, as discussed above, the zero exposure level entries 312 and 314 can be adjusted based on exposure levels of other boards in the same segment or other similar segments (e.g., one of the segments 122, 124, and 126 of FIG. 1) and/or other boards of similar site types in other segments.

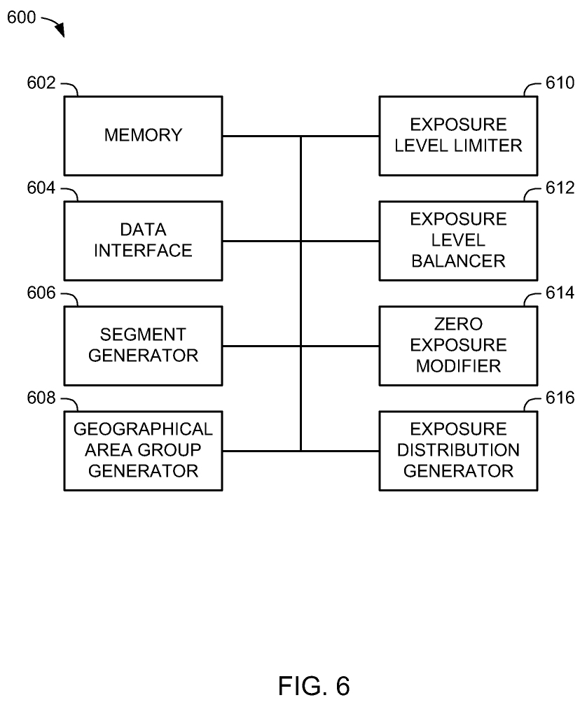

FIG. 5 is an example board exposure performance table 500 comparatively displaying standard error values and confidence intervals between pre-processed board exposure level values and post-processed board exposure level values. The example board exposure performance table 500 is used to illustrate, by way of example, the amount of error that can be reduced in board exposure measurement data using the example methods and apparatus described herein. Although the example table 500 shows reductions in errors by particular amounts, the amount of error reduction may be different in other example implementations.

In the illustrated example, the performance table 500 includes a measurement data section 502 having a number of boards column 504 showing how many boards were involved in a particular exposure measurement and a 28-day gross rating points (GRP's) column 506 to indicate board exposure levels for the number of boards in the number of boards column 504. In the illustrated example, a board exposure level is represented using a GRP, which is a measure of one percent of the population such that one GRP unit is based on one hundred people. In the illustrated example of FIG. 5, for ten measured boards as indicated in the first row of the number of boards column 504, the 28-day GRP was 52 as indicated in the 28-day GRP column 506, which means that 100 people selected randomly from the survey population would be exposed to one or more of the ten boards 52 times within a 28-day period.

The example performance table 500 includes a pre-processed performance section 508 having data that quantifies the accuracy and reliability of the measurement data in the measurement data section 502 prior to processing the measurement data using the example methods and apparatus described herein. A standard error column 510 includes standard error values for each of the GRP values in the 28-day GRP column 506. Each standard error value can be determined using statistical techniques applied to the survey data to identify or determine margins of error.

In the illustrated example, the pre-processed performance section 508 also includes a confidence interval column 512 to indicate the reliability of the GRP values in the 28-day GRP's column 506. For example, the confidence interval values can be used to describe the level of reliability of the 28-day GRP survey results. In the illustrated example, a GRP result with a small confidence interval is more reliable than a GRP result with a large confidence interval. In the illustrated example, the values in the confidence interval column 512 are based on a 95% confidence. In other examples, any other percentage of confidence may be used to evaluate the accuracy of the GRP data.

The example performance table 500 is also shown as having a post-processed performance section 514 that quantifies the accuracy and reliability of the measurement data in the measurement data section 502 after processing the measurement data using the example methods and apparatus described herein. In the illustrated example, a smoothed standard error column 516 includes standard error values for smoothed GRP values determined by processing the GRP values in the 28-day GRP column 506 using the example techniques described herein. As shown, the smoothed standard error values are relatively lower than respective ones of the standard error values of the standard error column 510.

The example performance table 500 also includes a smoothed confidence interval column 518 including confidence intervals indicating the reliability of smoothed GRP values determined by processing the GRP values in the 28-day GRP's column 506 using the example techniques described herein. As shown, the smoothed confidence intervals of the smoothed confidence interval column 518 are relatively smaller than corresponding ones of the confidence intervals of the confidence interval column 512. In the illustrated example, a GRP result with a small confidence interval is more reliable than a GRP result with a large confidence interval. Although the standard error values and the confidence interval values in the post-processed performance section 514 are indicative of a particular improvement in accuracy and/or reliability that can be achieved using the example techniques described herein, different manners of implementing the example methods and apparatus described herein can yield results different from those shown in the post-processed performance section 514.

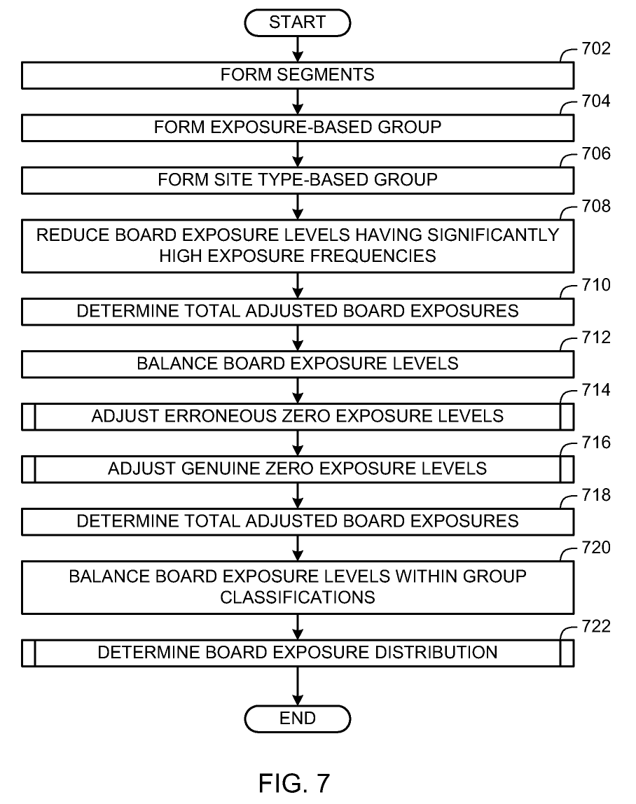

FIG. 6 is a block diagram of an example apparatus 600 that may be used to determine individual board exposure levels by processing measured board exposure levels to reduce inaccuracies and errors and, thus, increase the accuracy and/or reliability of those exposure level measurements. In the illustrated example, the example apparatus 600 includes a memory 602, a data interface 604, a segment generator 606, a geographical area group generator 608, an exposure level limiter 610, an exposure level balancer 612, a zero exposure modifier 614, and an exposure distribution generator 616. The example apparatus 600 may be implemented using any desired combination of hardware, firmware, and/or software. For example, one or more integrated circuits, discrete semiconductor components, and/or passive electronic components may be used. Thus, for example, any of the memory 602, the data interface 604, the segment generator 606, the geographical area group generator 608, the exposure level limiter 610, the exposure level balancer 612, the zero exposure modifier 614, and/or the exposure distribution generator 616, or parts thereof, could be implemented using one or more circuit(s), programmable processor(s), application specific integrated circuit(s) (ASIC(s)), programmable logic device(s) (PLD(s)) and/or field programmable logic device(s) (FPLD(s)), etc.

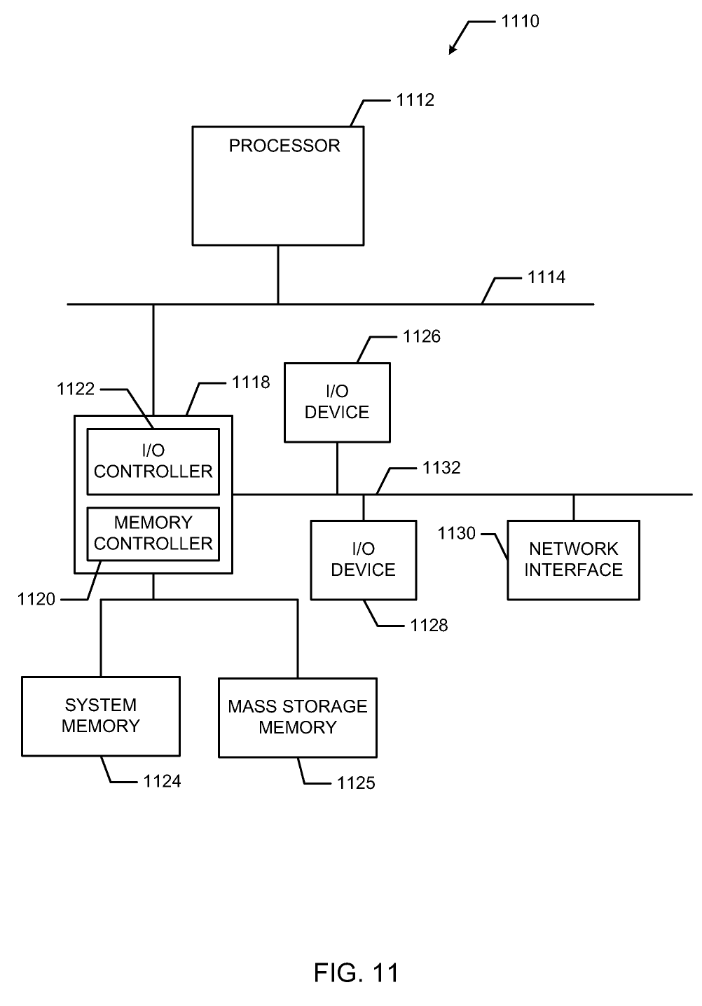

Some or all of the memory 602, the data interface 604, the segment generator 606, the geographical area group generator 608, the exposure level limiter 610, the exposure level balancer 612, the zero exposure modifier 614, and/or the exposure distribution generator 616, or parts thereof, may be implemented using instructions, code, and/or other software and/or firmware, etc. stored on a machine accessible medium that, are executed by, for example, a processor system (e.g., the example processor system 1110 of FIG. 11). When any of the appended claims are read to cover a purely software and/or firmware implementation, at least one of the data interface 604, the segment generator 606, the geographical area group generator 608, the exposure level limiter 610, the exposure level balancer 612, the zero exposure modifier 614, and/or the exposure distribution generator 616 is hereby expressly defined to include a tangible medium such as a memory, DVD, CD, etc. storing such software and/or firmware

To store board exposure level measurement data and processed or smoothed board exposure level values, the example apparatus 600 is provided with a memory 602. To access the memory 602, the apparatus 600 is provided with a data interface 604, which can read data from the memory 602 and write data to the memory 602. To generate segments (e.g., the segments 122, 124, and 126 of FIG. 1) that include boards expected to have substantially similar exposure levels, the example apparatus 600 is provided with a segment generator 606. In the illustrated example of FIG. 1, the boards 102a-c are expected to have similar exposure levels because they are all located along the same highway 104 and are all facing toward the same direction and, thus, the segment generator 606 can group the boards 102a-c into the segment 122.

To generate groups (e.g., the geographical area groups 128 and 130 of FIG. 1) that include boards based on different governmental and/or natural geographic demarcated areas (e.g., towns, cities, counties, provinces, states, territories, islands, etc.), the example apparatus 200 is provided with a geographical area group generator 608. In the illustrated example, the geographical area group generator 608 is configured to generate exposure level based groups such that boards within a particular geographic area expected to have similar exposure levels are grouped in a first group, while boards within the same geographic area expected to have similar exposure levels different from those of the first group are grouped in a different group. Each group can have one or more segments. For example, the province of Gauteng in the example table 300 of FIG. 3 can include a group of boards where different ones of the boards also form different segments such as one or more of the segments 122, 124, and 126 of FIG. 1. In particular, a low-exposure group in Gauteng may include the boards 106 and 110 within the segments 124 and 126 because the boards 106 and 110 are expected to have relatively low exposure levels, while a high-exposure group in Gauteng may include the boards 102a-c within the segment 122 and other segments along highways because the boards 102a-c are expected to have relatively high exposure levels.

In the illustrated example, the geographical area group generator 608 is also configured to group boards based on board type or site type. For example in FIG. 1, the geographical area group generator 608 can group the boards 106 and 110 and other similar wall mural type boards into the mural group 130 because those boards are of the same wall mural site type. Similarly, the geographical area group generator 608 can group the boards 102a-c and other billboard type boards into the billboard group 128 because those boards are of the same billboard site type.

To correct board exposure levels indicative of frequencies of exposure that are inaccurately higher than similar boards within the same segment or group to more credible frequencies, the example apparatus 200 is provided with an exposure level limiter 610. In the illustrated example, frequency of exposure is indicative of the average number of times a panel member viewed a particular board during a particular time period (e.g., a number of days, a week, a month, etc.). The frequency of exposure is derived by dividing the GRP of the particular board by the total non-duplicated panel members that may be exposed to that board. For example, if a board had 30 GRP's and a frequency of exposure of 20, then the average frequency of exposure for that board would be 1.5 exposures per panel member. In the illustrated example, the exposure level limiter 610 may cap, limit, or otherwise reduce exposure levels using any suitable technique. For example, the exposure level limiter 610 may normalize board exposure levels indicative of inaccurately higher exposure frequencies than board exposure levels of similar boards or similarly situated boards. Alternatively or additionally, the exposure level limiter 610 may determine a credible exposure level (e.g., a credible maximum exposure level or a credible average exposure level) based on other similar or similarly situated boards and adjust the exposure levels indicative of inaccurately higher exposure frequencies to the credible exposure level.

To balance board exposure levels of different boards within a segment (e.g., one of the segments 122, 124, or 126 of FIG. 1) or a group (e.g., one of the groups 128 or 130 of FIG. 1), the example apparatus 600 is provided with an exposure level balancer 612. In the illustrated example, the exposure level balancer 612 is configured to substantially reduce or eliminate disproportionate exposure levels of boards in the same segment or group by determining the total number of exposures for all the boards in that segment or group and redistributing the total exposures among the different boards in a balanced or proportionate manner so that each board has an exposure level that is substantially similar to the exposure levels of the other boards. The exposure level balancer 612 is configured to operate in this manner to preserve the number of the total exposures for a segment or group even though the exposures are redistributed among different boards within the segment or group. For example, referring to the segment 122 of FIG. 1, to balance the exposure levels of the boards 102a-c the exposure level balancer 612 retrieves the board exposure level value for each of the boards 102a-c and adds the exposure levels to determine the total exposures for the segment 122. The exposure level balancer 612 then redistributes the total exposures substantially equally among all of the boards 102a-c.

To adjust exposure levels of boards indicated as having zero exposure levels, the example apparatus 600 is provided with a zero exposure modifier 614. For example, the zero exposure modifier 614 can be used to detect the zero exposures of the zero exposure level entries 312 and 314 of FIG. 3 and adjust the zero exposures to a more credible exposure level. The more credible exposure level may be determined based on exposure levels of similar site types or other boards within the same segment or group. For example, the zero exposure level modifier 614 can be configured to adjust zero exposure measurements to exposure levels that are substantially similar (e.g., an average exposure level) to exposure levels of similar site type boards or boards situated in similar locations or the same locations.

To determine distributions of exposures among different boards within particular geographic boundaries, the example apparatus 600 is provided with an exposure distribution generator 618. In the illustrated example, the exposure distribution generator 616 is configured to receive adjusted exposure values modified by, for example, the zero exposure modifier 614, the exposure level balancer 612, and/or the exposure level limiter 610 and determine exposure level distributions having the most likely probability of occurrence. In the illustrated example, the exposure distribution generator 618 is configured to use a Bayesian smoothing process to determine exposure level distributions. However, in other example implementations, the exposure distribution generator 618 may additionally or alternatively be configured to use other statistical operations to determine exposure level distributions.

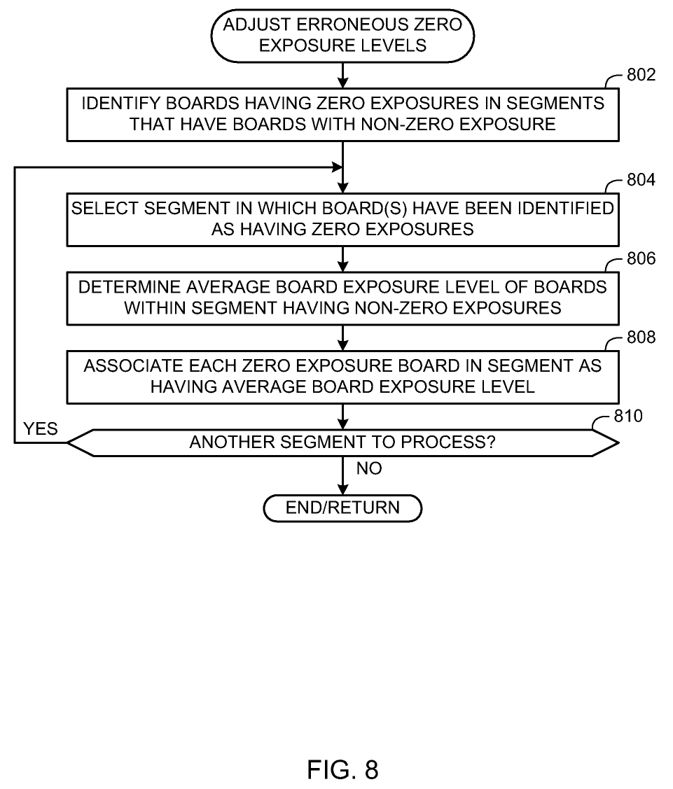

FIGS. 7-9, 10A, and 10B are flow diagrams representative of example machine readable instructions that may be executed to implement the example apparatus 600 of FIG. 6 to determine individual board exposure levels by processing measured board exposure levels to reduce inaccuracies and errors and, thus, increase the accuracy and/or reliability of those exposure level measurements. The example processes of FIGS. 7-9, 10A, and 10B may be performed using a processor, a controller and/or any other suitable processing device. For example, the example processes of FIGS. 7-9, 10A, and 10B may be implemented in coded instructions stored on a tangible medium such as a flash memory, a read-only memory (ROM) and/or random-access memory (RAM) associated with a processor (e.g., the example processor 1105 discussed below in connection with FIG. 11). Alternatively, some or all of the example processes of FIGS. 7-9, 10A, and 10B may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 7-9, 10A, and 10B may be implemented manually or as any combination(s) of any of the foregoing techniques, for example, any combination of firmware, software, discrete logic and/or hardware. Further, although the example processes of FIGS. 7-9, 10A, and 10B are described with reference to the flowcharts of FIGS. 7-9, 10A, and 10B, other methods of implementing the processes of FIGS. 7-9, 10A, and 10B may be employed. For example, the order of execution of the blocks may be changed, and/or some of the blocks described may be changed, eliminated, sub-divided, or combined. Additionally, any or all of the example processes of FIGS. 7-9, 10A, and 10B may be performed sequentially and/or in parallel by, for example, separate processing threads, processors, devices, discrete logic, circuits, etc.

Turning to FIG. 7, initially, the segment generator 606 (FIG. 6) forms one or more segments (block 702) such as, for example, the segments 122, 124, and 126 of FIG. 1. In the illustrated example, there are four segment classifications that include an area classification (e.g., geographic areas), a site-type classification, a primary road classification (e.g., a high-traffic highway traversing a geographic area), and an all roads classification (e.g., a segment including all roads in a geographic area).

The geographical area group generator 608 (FIG. 6) then forms an exposure-based group (G_{E}) (block 704) and a site type-based group (G_{S}) (block 706). As discussed above in connection with FIG. 6, an exposure-based group may be formed to include boards within a particular geographic area expected to have similar exposure levels and a site type-based group may be formed to include boards within a particular geographic area of the same site type. In the illustrated example of FIG. 1, the example billboard group 128 includes the boards 102a-c and 132 of the billboard type and the example mural group 130 includes the boards 106 and 110 of the wall mural type.

The exposure level limiter 610 (FIG. 6) reduces (e.g., limits or caps) board exposure levels having inaccurately high exposure frequencies (block 708). In the illustrated example, the exposure level limiter 610 identifies a board as having an inaccurately high exposure frequency when its board exposure level is higher than a threshold amount above the board exposure level for similar boards within the same segment or group. In some example implementations, the exposure level limiter 610 may determine which boards have inaccurately high exposure frequency by comparing the exposure frequency values of the boards with a predetermined exposure frequency threshold. The exposure frequency threshold can be determined based on an acceptable or more credible maximum exposure frequency associated with, for example, historical exposure measurements indicative of credible maximum exposure frequencies. The exposure level limiter 610 can then limit the exposure frequencies identified as being too high to the more credible or acceptable exposure frequency. In the illustrated example, the exposure level limiter 610 implements the operation of block 708 by identifying each board having an exposure frequency (F) greater than an exposure frequency threshold of 3 and determining an adjusted or reduced raw duplicated daily exposure level (RA_{b}) of each of the identified boards using equation 1 below. Exposure frequency (F) is used to represents how often the same people were exposed to a particular board (b) during a particular period (e.g., a number of days, a week, etc.) and is used in equation 1 below to adjust statistically outlying exposure levels. For example, if the same person walked by a board 81 times, that board would appear to have a high exposure level. However, this will be an artificially high exposure level because 81 of the exposures were attributable to the same person.

$${RA}_{b} = \frac{3}{{F}_{b}} \times {R}_{b} \qquad Equation 1$$

In equation 1 above, the adjusted or reduced raw duplicated daily exposure level (RA_{b}) for each board (b) is the reduced exposure level that is representative of all exposures for that board including duplicated exposures to the same panel members. Using equation 1 above, the adjusted or reduced raw duplicated daily exposure level (RA_{b}) for each board (b) is determined by dividing three (3) by the exposure frequency (F_{b}) for that board (b) to determine a quotient

$$( \frac{3}{{F}_{b}} )$$

and multiplying the quotient

$$( \frac{3}{{F}_{b}} )$$

by the non-adjusted raw duplicated daily exposure level (R_{b}) for that board (b). In the illustrated example, the exposure frequency (F_{b}) is a 9-day weighted frequency to emphasize frequency levels that had the highest levels of occurrence among different panel members over a 9-day period. For example, if a particular board (b) is exposed to 10 people, eight of which account for 81 exposures each (i.e., a frequency of 81) and two of which account for 50 exposures each for a 9-day duration, weighting the frequencies would set the exposure frequency (F_{b}) to a value that is relatively closer to 81 than 50, thus emphasizing that more people had a higher level of exposure for that board (b).

The exposure level balancer 612 (FIG. 6) determines the total adjusted board exposures (E_{adj(1)}) (block 710). That is, after the exposure level limiter 610 reduces the exposure frequencies of the boards identified at block 708, the exposure level balancer 612 determines the total number of board exposures for all of the boards in the segments and groups formed at blocks 702, 704, and 706 including boards having exposures that were not reduced at block 708 and the boards having the reduced raw duplicated daily exposure levels (RA_{b}). The exposure level balancer 612 then balances the board exposure levels (block 712) determined at block 710 among all boards by determining a balanced raw duplicated daily exposure level (RB1_{b}) for each board (b). In the illustrated example, the exposure level balancer 612 determines the balanced raw duplicated daily exposure level (RB1_{b}) for each board (b) using equation 2 or equation 3 below.

$$\begin{matrix}RB {1}_{b} = {RA}_{b} \times \frac{E}{{E}_{adj ( 1 )}} & Equation 2 \\ RB {1}_{b} = {R}_{b} \times \frac{E}{{E}_{adj ( 1 )}} & Equation 3\end{matrix}$$

Equation 2 is used for boards having a reduced raw duplicated daily exposure level (RA_{b}) (as determined at block 708), and equation 3 is used for boards that did not have their exposure levels reduced at block 708 (i.e., boards that did not have an incorrectly high exposure frequency). As shown in equation 2 above, the balanced raw duplicated daily exposure level (RB1_{b}) for each adjusted board is determined by dividing the total board exposures (E) (summed across all the boards in the segments and groups formed at blocks 702, 704, and 706) by the total adjusted board exposures (E_{adj(1)}) determined at block 710 to determine a quotient

$$( \frac{E}{{E}_{adj ( 1 )}} )$$

and multiplying the quotient

$$( \frac{E}{{E}_{adj ( 1 )}} )$$

by the adjusted or reduced raw duplicated daily exposure level (RA_{b}) determined at block 708 for that adjusted board. Using equation 3, the balanced raw duplicated daily exposure level (RB1_{b}) for each non-adjusted board is determined by multiplying the quotient

$$( \frac{E}{{E}_{adj ( 1 )}} )$$

by the raw duplicated daily exposure level (R_{b}) for that non-adjusted board.

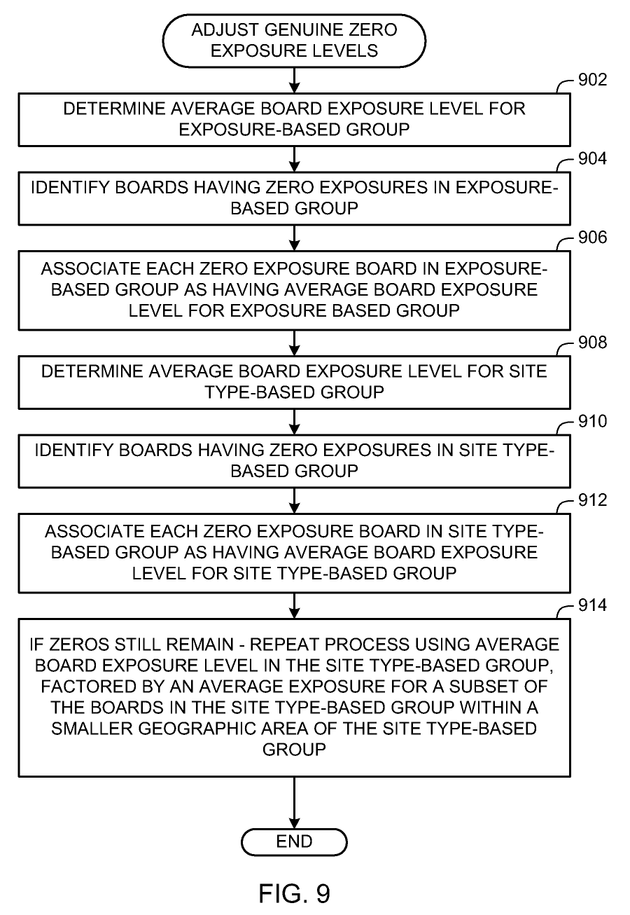

The zero exposure modifier 614 (FIG. 6) adjusts erroneous zero exposure levels (block 714) to determine zero-adjusted daily exposure levels (RZA_{b}). For example, because some non-adjusted boards may have zero exposure levels (i.e., the raw duplicated daily exposure level (R_{b}) is equal to zero), the balanced raw duplicated daily exposure level (RB1_{b}) for those zero exposure boards will remain zero after balancing board exposures at block 712. Thus, the zero exposure modifier 614 determines zero-adjusted daily exposure levels (RZA_{b}) by correcting exposure levels that have erroneously been attributed an exposure level of zero. In some instances, a board may be attributed as having zero exposures if the board is characterized or categorized improperly as facing the wrong direction. For example, if a board is categorized as facing south on a one-way road having a south-bound direction of travel, depending on pedestrian traffic, the board might appear to have zero exposures because the incorrectly indicated facing direction indicates that no motorists or vehicular passengers were able to see the information on the board. An example process that can be used to determine zero-adjusted daily exposure levels (RZA_{b}) by adjusting erroneous zero exposure levels is discussed below in connection with FIG. 8.

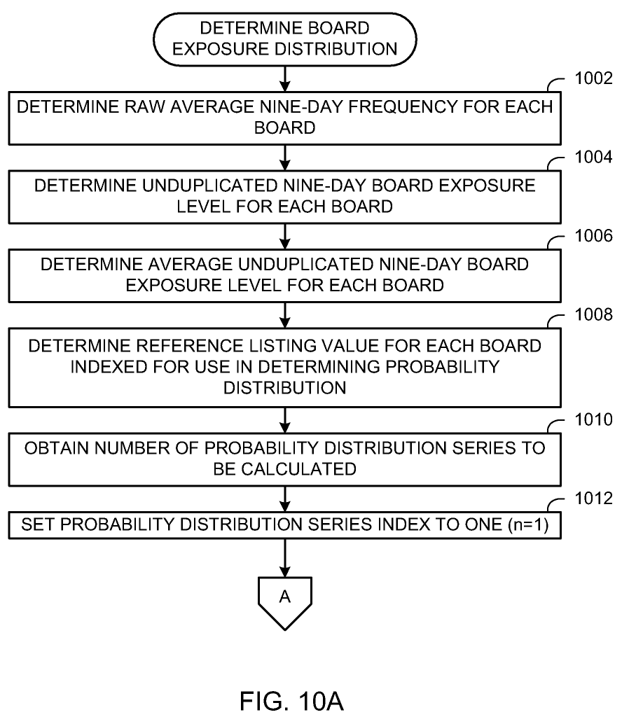

The zero exposure modifier 614 also determines zero-adjusted daily exposure levels (RZA_{b}) by adjusting exposure levels of boards having genuine zero exposure levels (block 716). A genuine zero exposure level is one that accurately indicates that a corresponding board was not exposed to any of the people of a particular representative panel even though the board was likely exposed to other people of the general public that were not part of the representative panel. An example process that can be used to determine zero-adjusted daily exposure levels (RZA_{b}) by adjusting genuine zero exposure levels is discussed below in connection with FIG. 9.

The exposure level balancer 612 determines the total adjusted board exposures (E_{adj(2)}) (block 718). That is, after the zero exposure modifier 614 adjusts the erroneous and genuine zero exposures at blocks 714 and 716, the exposure level balancer 612 determines the total number of board exposures for all of the boards (i.e., adjusted and non-adjusted boards) in the segments and groups formed at blocks 702, 704, and 706.

The exposure level balancer 612 then balances the board exposure levels (block 720) for each site-type classification within the exposure-based group (G_{E}) formed at block 704 to determine balanced raw duplicated daily exposure levels (RBG_{Eb}) for the boards (b) in the exposure-based group (G_{E}). In the illustrated example, the exposure level balancer 612 determines the balanced raw duplicated daily exposure level (RBG_{Eb}) for each board (b) using equation 4, equation 5, or equation 6 below.

$$\begin{matrix}{RBG}_{Eb} = {RZA}_{b} \times \frac{\sum {RG}_{E}}{\sum ( RZA , RA , R )} & Equation 4 \\ {RBG}_{Eb} = {RA}_{b} \times \frac{\sum {RG}_{E}}{\sum ( RZA , RA , R )} & Equation 5 \\ {RBG}_{Eb} = {R}_{b} \times \frac{\sum {RG}_{E}}{\sum ( RZA , RA , R )} & Equation 6\end{matrix}$$

Equation 4 is used for boards having a zero-adjusted daily exposure level (RZA_{b}) (as determined at block 716), equation 5 is used for boards having a reduced raw duplicated daily exposure level (RA_{b}) (as determined at block 708), and equation 6 is used for boards that did not have their exposure levels modified (i.e., boards that did not have an inaccurately high exposure frequency nor zero exposure levels). As shown in equation 4 above, to determine a balanced raw duplicated daily exposure level (RBG_{Eb}) for each board (b) in the exposure-based group (G_{E}) having a zero-adjusted daily exposure level (RZA_{b}), a sum (ΣRG_{E}) of the raw duplicated daily exposures for every board in the exposure-based group (G_{E}) is divided by a sum (Σ(RZA, RA, R)) of the zero-adjusted daily exposure levels (RZA), the reduced raw duplicated daily exposure levels (RA), and the non-adjusted raw duplicated daily exposure levels (R) of all the boards in the exposure-based group (G_{E}) to determine a quotient

$$( \frac{\sum {RG}_{E}}{\sum ( RZA , RA , R )} ) ,$$

and the quotient

$$( \frac{\sum {RG}_{E}}{\sum ( RZA , RA , R )} )$$

is multiple by the zero-adjusted daily exposure level (RZA_{b}) of that board (b). As shown in equation 5 above, to determine a balanced raw duplicated daily exposure level (RBG_{Eb}) for each board (b) in the exposure-based group (G_{E}) having a reduced raw duplicated daily exposure level (RA_{b}), the quotient

$$( \frac{\sum {RG}_{E}}{\sum ( RZA , RA , R )} )$$

is multiplied by the reduced raw duplicated daily exposure level (RA_{b}) for that board (b). As shown in equation 6, to determine a balanced raw duplicated daily exposure level (RBG_{Eb}) for each board (b) in the exposure-based group (G_{E}) having a non-adjusted raw duplicated daily exposure level (R_{b}), the quotient

$$( \frac{\sum {RG}_{E}}{\sum ( RZA , RA , R )} )$$

is multiplied by the non-adjusted raw duplicated daily exposure level (R_{b}) for that board (b).

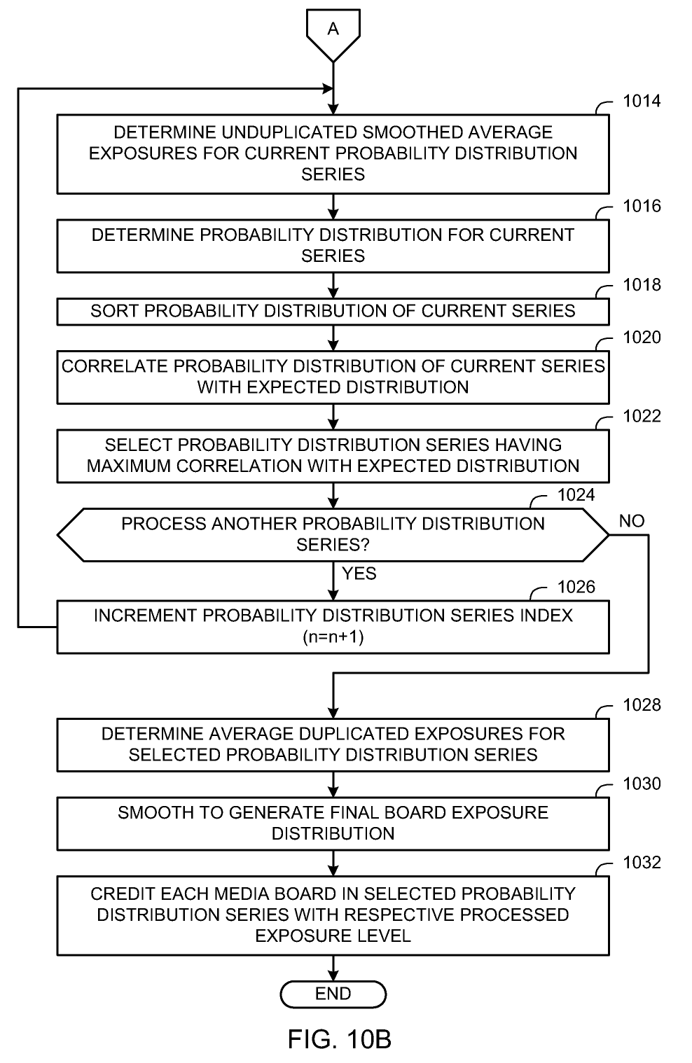

The exposure distribution generator 616 (FIG. 6) determines a board exposure distribution (block 722) using a smoothing technique. In the illustrated example, the board exposure distribution process of block 722 is used to determine a plurality of possible board exposure distributions and identify the most likely distribution of exposures among all of the boards by selecting a most probable one of the plurality of possible board exposure distributions. An example process that may be used to determine the board exposure distribution at block 722 is described below in connection with FIGS. 10A and 10B. The example process of FIG. 7 then ends.

Turning to FIG. 8, the illustrated example process may be used to adjust erroneous zero exposure levels of boards (b) to determine zero-adjusted daily exposure levels (RZA_{b}) of those boards (b). The example process of FIG. 8 can be used to implement the operations of block 714 described above in connection with FIG. 7. Initially, the zero exposure modifier 614 (FIG. 6) identifies boards having zero exposures in segments that have boards having non-zero exposure levels (block 802). For example, if each of the segments 122, 124, and 126 of FIG. 1 has at least one board having a non-zero exposure level, then the zero exposure modifier 614 searches for any other boards having zero exposure levels within each of the segments 122, 124, and 126.

The zero exposure modifier 614 then selects a segment (e.g., one of the segments 122, 124, or 126) in which it identified one or more board(s) as having zero exposures (block 804). The zero exposure modifier 614 then determines an average board exposure level of all the boards having non-zero exposure levels within the selected segment (block 806). The zero exposure modifier 614 then associates each zero exposure board identified at block 804 within the selected segment with the average board exposure level (block 808) determined at block 806. That is, the zero-adjusted daily exposure level (RZA_{b}) for each board (b) having been identified as having zero exposures is set equal to the average board exposure level determined at block 806.

The zero exposure modifier 614 then determines whether there are any other segments to process (block 810). For example, if any other one of the segments 122, 124, or 126 was identified as having one or more boards with zero exposures, control returns to block 804, and the zero exposure modifier 614 selects another one of the segments 122, 124, and 126 to process. Otherwise, if no other segments remain to be processed (block 810), the example process of FIG. 8 ends and control returns to a calling process or function such as the example process of FIG. 7.

Turning to FIG. 9, the illustrated example process may be used to adjust exposure levels for boards having genuine zero exposure levels by determining zero-adjusted daily exposure levels (RZA_{b}) for those boards. The example process of FIG. 9 can be used to implement the operations of block 716 of FIG. 7. Initially, the zero exposure modifier 614 (FIG. 6) determines an average board exposure level for the exposure-based group (G_{E}) (block 902) formed at block 704 of FIG. 7. The zero exposure modifier 614 then identifies boards in the exposure-based group (G_{E}) having zero exposures (block 904). The zero exposure modifier 614 then associates each zero exposure board identified at block 904 within the exposure-based group (G_{E}) with the average board exposure level (block 906) determined at block 904. That is, the zero-adjusted daily exposure level (RZA_{b}) for each board (b) having been identified as having zero exposures in the exposure-based group (G_{E}) is set equal to the average board exposure level determined at block 904.

The zero exposure modifier 614 determines an average board exposure level for the site-type-based group (G_{S}) (block 908) formed at block 706 of FIG. 7. The zero exposure modifier 614 then identifies boards in the site-type-based group (G_{S}) having zero exposures (block 910). The zero exposure modifier 614 then associates each zero exposure board identified at block 910 within the site-type-based group (G_{S}) with the average board exposure level (block 912) determined at block 908. That is, the zero-adjusted daily exposure level (RZA_{b}) for each board (b) having been identified as having zero exposures in the site-type-based group (G_{S}) is set equal to the average board exposure level determined at block 908.

If zeros still remain, the zero exposure modifier 614 can repeat the process of FIG. 9 using an average board exposure level in the site type-based group, factored by an average exposure for a subset of the boards in the site type-based group (G_{S}) that are within a smaller geographic area than the larger geographic area covered by the site type-based group (G_{S}) (block 914). For example, if the site type-based group (G_{S}) covers a province, at block 908 the zero exposure modifier 614 can determine the average board exposure level for all of the boards within the province factored by an average exposure level for a subset of the boards within a smaller geographic area (e.g., an urban area or a rural area) in the province. The example process of FIG. 9 then ends and control returns to a calling process or function such as the example process of FIG. 7.

Turning to FIGS. 10A and 10B, the illustrated example process can be used to determine a board exposure distribution using a Bayesian smoothing technique. In the illustrated example, the board exposure distribution is determined based on a nine-day exposure measurement period. However, other measurement periods may be used in alternative example implementations. In addition, although the operations discussed below to describe the process of FIGS. 10A and 10B are used to implement a Bayesian smoothing technique, the operations may be modified to implement any other type of smoothing technique. The example process of FIGS. 10A and 10B can be used to implement the operations of block 722 discussed above in connection with FIG. 7. Initially, the exposure distribution generator 616 (FIG. 6), determines a raw average nine-day frequency (FA_{b}) for each board (b) (block 1002) in the segments and groups formed at blocks 702, 704, and 706. In the illustrated example, the exposure distribution generator 616 determines the raw average nine-day frequency (FA_{b}) using equation 7 below.

$${FA}_{b} = \frac{T \times \sum R}{\sum V} \qquad Equation 7$$

Using equation 7 above, the raw average nine-day frequency (FA_{b}) is determined by multiplying a measurement time period (T) (which is nine in the illustrated example for the nine-day period) by the sum of the non-adjusted raw duplicated daily exposure levels (R) of all the boards in the segments and groups formed at blocks 702, 704, and 706 of FIG. 7 to determine a product (T×ΣR). The product (T×ΣR) is then divided by the sum of raw unduplicated nine-day exposures (ΣV) of all the boards. For each board, the raw unduplicated nine-day exposures (V) represent the number of times that people were exposed to that board within a nine-day period without counting repeated exposures associated with the same people. For example, if the same person was exposed to a particular board 20 times within the nine-day period, only one of those times would be counted for the raw unduplicated nine-day exposures (V).

The exposure distribution generator 616 then determines an unduplicated nine-day board exposure level (U_{b}) for each board (b) (block 1004). In the illustrated example, the exposure distribution generator 616 determines the unduplicated nine-day board exposure levels (U_{b}) using equation 8 below.

$${U}_{b} = T \times \frac{{RBG}_{Eb}}{{FA}_{b}} \qquad Equation 8$$

Using equation 8 above, the unduplicated nine-day board exposure level (U_{b}) for each board (b) is determined by dividing the balanced raw duplicated daily exposure level (RBG_{Eb}) for each board (b) (determined at block 720 of FIG. 7) by the raw average nine-day frequency (FA_{b}) (determined at block 1002) to determine a quotient

$$( \frac{{RBG}_{Eb}}{{FA}_{b}} ) ,$$

and the quotient

$$( \frac{{RBG}_{Eb}}{{FA}_{b}} )$$

is multiplied by the measurement time period (T) (which is nine in the illustrated example for the nine-day period).

The exposure distribution generator 616 determines an average nine-day board exposure level (UA_{b}) for each board (b) (block 1006). In the illustrated example, the exposure distribution generator 616 determines the average nine-day board exposure levels (UA_{b}) using equation 9 below.

$${UA}_{b} = T \times \frac{\sum {RBG}_{E}}{{FA}_{b}} \qquad Equation 9$$

Using equation 9 above, the average nine-day board exposure level (UA_{b}) for each board (b) is determined by dividing the sum of the balanced raw duplicated daily exposure level (RBG_{E}) for all the boards by the raw average nine-day frequency (FA_{b}) to determine a quotient

$$( \frac{\sum {RBG}_{E}}{{FA}_{b}} ) ,$$

and the quotient

$$( \frac{\sum {RBG}_{E}}{{FA}_{b}} )$$

is multiplied by the measurement time period (T).

The exposure distribution generator 616 then determines a reference listing value (Z_{b}) for each board (b) indexed for use in determining probability distributions (block 1008). The reference listing value (Z_{b}) for all the boards (b) is indicative of an expected distribution (Z). In the illustrated example, the exposure distribution generator 616 determines the reference listing value (Z_{b}) using equation 10 below.

$${Z}_{b} = \frac{i}{N} \qquad Equation 10$$

As shown in equation 10 above, the reference listing value (Z_{b}) for each board (b) is determined by dividing a board index value (i) by the total number of boards (N) used to determine a probability distribution. In the illustrated example, the board index value (i) is equal to the board number (b) (i.e., i=b). If there were 100 total boards (i.e., N=100) in a study, the reference listing value (Z_{b}) for the first board (i=b=1) would be 0.01 (i.e., Z_{b}=0.01= 1/100) and the expected distribution (Z) would be 0.01, 0.02, 0.03, . . . 0.97, 0.98, 0.99, 1.00.

The exposure distribution generator 616 then obtains the number (D) of probability distribution series to be calculated (block 1010). For example, a user may specify the number (D) of probability distribution series to be calculated based on a number of values to be used to vary a particular model parameter. For example, a model parameter to be varied may be a true population value representative of the population in a particular area in which the boards are located. For forty different population values (e.g., 10,000 people, 20,000 people, 40,000 people, etc.), a user may specify that the exposure distribution generator 616 should determine forty probability distribution series (i.e., D=40). The exposure distribution generator 616 then sets a probability distribution series index to one (block 1012) (i.e., n=1, where n increments from D=1 to 40).

Turning to FIG. 10B, the exposure distribution generator 616 determines an unduplicated smoothed average exposure series (US(n)) for all of the boards for the current probability distribution series (e.g., n=1) (block 1014). In the illustrated example, the exposure distribution generator 616 determines the unduplicated smoothed average exposure series (US(n)) using equation 11 below.

$$US ( n ) = \frac{( n \times {U}_{b} ) + {UA}_{b}}{n + 1} , \\ where \\ b = 1 to N \qquad Equation 11$$

As shown in equation 11 above, the unduplicated smoothed average exposure series (US(n)) for the set of boards (b=1 to N) is determined by multiplying the current probability distribution index value (n) by the unduplicated nine-day board exposure level (U_{b}) to determine a product (n×U_{b}) and adding the product (n×U_{b}) to the average nine-day board exposure level (UA_{b}) to determine a sum ((n×U_{b})+UA_{b}). The sum ((n×U_{b})+UA_{b}) is then divided by the sum of the current probability distribution index value (n) added to one.

The exposure distribution generator 616 then determines the probability distribution (prob(V)) for the current probability distribution series (block 1016). In the illustrated example, the exposure distribution generator 616 determines the probability distribution (prob(V)) assuming that a true value is equal to the unduplicated smoothed average exposure series (US(n)) and a standard error (SE) is as defined in equation 12 below.

$$SE = \sqrt{\frac{US ( n )}{K} \times \frac{\frac{1 - US ( n )}{K}}{Eff}} \qquad Equation 12$$

In equation 12 above, (K) is set to a population estimate and (Eff) is the effective or measured population.

The exposure distribution generator 616 then sorts the probability distribution (prov(V)) of the current probability distribution series (block 1018) and correlates the probability distribution (prov(V)) with the expected distribution (Z) (block 1020) to determine a correlation set (L(n)). The expected distribution (Z) for all boards (b) is determined above at block 1008. In the illustrated example, the exposure distribution generator 616 determines the correlation set (L(n)) using equation 13 below.

L(n)=Correl(prob(V),Z) Equation 13

The exposure distribution generator 616 then selects a probability distribution series having the maximum correlation (e.g., relatively better correlation) with the expected distribution (Z) (i.e., L(n)=max) (block 1022). For example, after one or more iterations of blocks 1014, 1016, 1018, and 1020 for different probability distribution indices (n), the exposure distribution generator 616 may compare the correlation performance of the correlated probability distribution values determined during a current iteration (i.e., n) of block 1020 with a correlation performance of correlated probability distribution values determined during a previous iteration (i.e., n−1) of block 1020 and determine which has a higher correlation performance (i.e., which correlates best with the expected distribution (Z)).

The exposure distribution generator 616 determines whether it should process another probability distribution series (block 1024). For example, the example process may repeat the operations of blocks 1014, 1016, 1018, 1020, and 1022 until all of the probability distribution series (D) specified at block 1010 (FIG. 10A) have been calculated. If the exposure distribution generator 616 determines that it should process another probability distribution series (block 1024), the exposure distribution generator 616 increments the probability distribution series index (i.e., n=n+1) (block 1026) to select another one of the plurality of probability distribution series for processing and control returns to block 1014.

If at block 1024, the exposure distribution generator 616 determines that it should not process another probability distribution series, control passes from block 1024 to block 1028 and the exposure distribution generator 616 determines average duplicated exposures (M) for the probability distribution series selected at block 1022 (block 1028). In the illustrated example, the exposure distribution generator 616 determines the average duplicated exposures (M) using equation 14 below.

$$M = \frac{\sum {RBG}_{E}}{N} \qquad Equation 14$$

As shown in equation 14 above, the average duplicated exposures (M) is determined by dividing the sum of the balanced raw duplicated daily exposure level (RBG_{E}) for every board in the exposure-based group (G_{E}) by the total number of boards (N) in the segments and groups formed at blocks 702, 704, and 706 of FIG. 7.

The exposure distribution generator 616 then smoothes the values of the probability distribution series selected at block 1022 to generate a final board exposure distribution (R_{dist}) (block 1030). In the illustrated example, the exposure distribution generator 616 smoothes the values of the selected probability distribution series using equation 15 below.

$${R}_{dist} = \frac{( n \times {RBG}_{E} ) + M}{n + M} \qquad Equation 15$$

As shown in equation 15 above, the series index number (n) of the probability distribution series selected at block 1022 is multiplied by the balanced raw duplicated daily exposure level (RBG_{E}) to produce a product (n×RBG_{E}) that is added to the average duplicated exposures (M) determined at block 1028 to determine a sum ((n×RBG_{E})+M). The final board exposure distribution (R_{dist}) is then determined by dividing the sum ((n×RBG_{E})+M) by the sum of the selected series index number (n) and the average duplicated exposures (M) (n+M). The exposure distribution generator 616 then credits each of the media boards in the selected probability distribution series with a respective processed exposure level (block 1032). In the illustrated example, a processed exposure level is one that is part of the smoothed probability distribution and was modified or adjusted during the smoothing operation of block 1030 and/or was used in the smoothing operation to modify or adjust other exposure levels in the probability distribution series without itself being modified or adjusted. The example process of FIGS. 10A and 10B then ends and control returns to a calling process or function such as the example process of FIG. 7.

FIG. 11 is a block diagram of an example processor system 1110 that may be used to implement the apparatus and methods described herein. As shown in FIG. 11, the processor system 1110 includes a processor 1112 that is coupled to an interconnection bus 1114. The processor 1112 may be any suitable processor, processing unit or microprocessor. Although not shown in FIG. 11, the system 1110 may be a multi-processor system and, thus, may include one or more additional processors that are identical or similar to the processor 1112 and that are communicatively coupled to the interconnection bus 1114.

The processor 1112 of FIG. 11 is coupled to a chipset 1118, which includes a memory controller 1120 and an input/output (I/O) controller 1122. As is well known, a chipset typically provides I/O and memory management functions as well as a plurality of general purpose and/or special purpose registers, timers, etc. that are accessible or used by one or more processors coupled to the chipset 1118. The memory controller 1120 performs functions that enable the processor 1112 (or processors if there are multiple processors) to access a system memory 1124 and a mass storage memory 1125.

The system memory 1124 may include any desired type of volatile and/or non-volatile memory such as, for example, static random access memory (SRAM), dynamic random access memory (DRAM), flash memory, read-only memory (ROM), etc. The mass storage memory 1125 may include any desired type of mass storage device including hard disk drives, optical drives, tape storage devices, etc.

The I/O controller 1122 performs functions that enable the processor 1112 to communicate with peripheral input/output (I/O) devices 1126 and 1128 and a network interface 1130 via an I/O bus 1132. The I/O devices 1126 and 1128 may be any desired type of I/O device such as, for example, a keyboard, a video display or monitor, a mouse, etc. The network interface 1130 may be communicatively coupled to a network and may be, for example, an Ethernet device, an asynchronous transfer mode (ATM) device, an 802.11 device, a DSL modem, a cable modem, a cellular modem, etc. that enables the processor system 1110 to communicate with another processor system.

While the memory controller 1120 and the I/O controller 1122 are depicted in FIG. 11 as separate blocks within the chipset 1118, the functions performed by these blocks may be integrated within a single semiconductor circuit or may be implemented using two or more separate integrated circuits.

The example methods and apparatus described herein can be used in connection with measuring board exposure levels by advantageously reducing sampling variability and increasing the ease of analysis of the measured data. Although the example methods and apparatus described herein are generally applicable to any type of market including small and large markets, the example methods and apparatus are advantageously useful in markets having areas where board exposure levels are difficult to measure or are unavailable based on, for example, traffic counts. That is, the techniques described herein can be used to infer board exposure levels for boards having zero measured exposures or inaccurately high or low exposure levels. The techniques described herein can be advantageously used to adjust inaccurate board exposure levels to proper or more credible board exposure levels based on relatively more accurate board exposure levels of other measured boards.

Each board in a campaign, when measured using a representative panel member sample, can have an inaccurate degree of variability relative to other boards in the same campaign. For example, a typical board can be exposed to less than 1% of a panel member sample, and the geographic separation between the different board sites and the panel member sample means that some sites have zero exposures to panel members while others have relatively higher exposures (e.g., if a person traveled past a board 81 times, this could result in an inaccurately high exposure level because the exposures were all to the same person).

The example methods and apparatus described herein can be advantageously used to analyze board exposure levels in areas where the number of measured boards is relatively small, and especially where boards are measured as having zero exposures. That is, the example methods and apparatus described herein can be advantageously used to smooth measured levels to reduce sampling errors associated with estimating individual board exposures (and, thus, campaigns having relatively few boards) by ensuring that the smoothed board exposure levels are within a range relative to unsmoothed exposure levels so that board exposure analyses will not be inaccurately biased toward inaccurate board exposure levels.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method comprising:
obtaining exposure levels associated with a plurality of media boards;
determining a plurality of probability distributions indicative of probable exposure levels for the plurality of media boards;
selecting one of the plurality of probability distributions corresponding to an expected distribution;
smoothing the selected probability distribution; and
crediting each of the plurality of media boards with a respective processed exposure level of the smoothed probability distribution.

2. A method as defined in claim 1, wherein at least some of the media boards are positioned in different geographic locations.

3. A method as defined in claim 1, further comprising:
identifying at least one of the media boards having a measured exposure frequency greater than an exposure frequency threshold; and
reducing the measured exposure level of the at least one of the media boards.

4. A method as defined in claim 1, further comprising balancing adjusted exposure levels and non-adjusted exposure levels corresponding to the exposure levels of the media boards.

5. A method as defined in claim 4, wherein each of the adjusted exposure levels is adjusted based on a corresponding one of the media boards being associated with a zero measured exposure level or a measured exposure frequency that is greater than an exposure frequency threshold.

6. A method as defined in claim 1, wherein smoothing the selected probability distribution comprises smoothing the selected probability distribution using a Bayesian smoothing process to adjust exposure levels that are relatively higher or lower than other exposure levels.

7. A method as defined in claim 1, further comprising categorizing subsets of the plurality of media boards based on at least one of site type or geographic area.

8. A method as defined in claim 7, wherein the site type specifies a type of media board comprising at least one of a billboard type, a mural type, a store facia type, or a bus shelter type.

9. A method as defined in claim 1, further comprising adjusting a first one of the exposure levels corresponding to a first one of the media boards based on a second one of the exposure levels corresponding to a second one of the media boards if the first and second media boards are at least one of a same board type or located along a same path of travel.

10. An apparatus to determine exposure levels of media boards, comprising:
a data interface to obtain exposure levels associated with a plurality of media boards; and
an exposure distribution generator to:
determine a plurality of probability distributions indicative of probable exposure levels for the plurality of media boards;
select a first one of the plurality of probability distributions having a relatively better correlation with an expected distribution than at least another one of the plurality of probability distributions;
smooth the first probability distribution; and
crediting each of the plurality of media boards with a respective processed exposure level of the smoothed probability distribution.

11. An apparatus as defined in claim 10, wherein at least some of the media boards are positioned in different geographic locations.

12. An apparatus as defined in claim 10, further comprising an exposure level limiter to:
identify at least one of the media boards having a measured exposure frequency greater than an exposure frequency threshold; and
reduce a measured exposure frequency of the at least one of the media boards to a level less than or equal to the exposure frequency threshold.

13. An apparatus as defined in claim 10, further comprising an exposure level balancer to balance adjusted and non-adjusted exposure levels corresponding to the exposure levels of the media boards.

14. An apparatus as defined in claim 13, further comprising:
an exposure level limiter to identify a first portion of the adjusted exposure levels that are associated with a corresponding first portion of the media boards having measured exposure frequencies that are greater than an exposure frequency threshold; and
a zero exposure modifier to identify at least a second portion of the adjusted exposure levels that are associated with a corresponding second portion of the media boards having zero exposures.

15. An apparatus as defined in claim 10, wherein the exposure distribution generator is further to smooth the selected probability distribution using a Bayesian smoothing process to adjust exposure levels that are relatively higher or lower than other exposure levels.

16. An apparatus as defined in claim 10, wherein the media boards are categorized based on at least one of site type or geographic area.

17. An apparatus as defined in claim 16, wherein the site type specifies a type of media board, the type of media board comprising at least one of a billboard type, a mural type, a store facia type, or a bus shelter type.

18. An apparatus as defined in claim 10, further comprising at least one of an exposure level limiter or a zero exposure modifier, the at least one of the exposure level limiter or the zero exposure modifier is to adjust a first one of the exposure levels corresponding to a first one of the media boards based on a second one of the exposure levels corresponding to a second one of the media boards if the first and second media boards are at least one of a same board type or located along a same path of travel.

19. A machine readable medium having instructions stored thereon that, when executed, cause a machine to:
obtain exposure levels associated with a plurality of media boards;
determine a plurality of probability distributions indicative of probable exposure levels for the plurality of media boards;
select one of the plurality of probability distributions corresponding to an expected distribution;
smooth the selected probability distribution; and
crediting each of the plurality of media boards with a respective processed exposure level of the smoothed probability distribution.

20. A machine readable medium as defined in claim 19, wherein at least some of the media boards are positioned in different geographic locations.

21. A machine readable medium as defined in claim 19 having instructions stored thereon that, when executed, cause the machine to:
identify at least one of the media boards having a measured exposure frequency greater than an exposure frequency threshold; and
reduce the measured exposure level of the at least one of the media boards.

22. A machine readable medium as defined in claim 19 having instructions stored thereon that, when executed, cause the machine to balance adjusted and non-adjusted exposure levels corresponding to the exposure levels of the media boards.

23. A machine readable medium as defined in claim 22 having instructions stored thereon that, when executed, cause the machine to determine the adjusted exposure levels based on a corresponding one of the media boards being associated with a zero measured exposure level or a measured exposure frequency that is greater than an exposure frequency threshold.

24. A machine readable medium as defined in claim 19, wherein smoothing the selected probability distribution comprises smoothing the selected probability distribution using a Bayesian smoothing process to adjust exposure levels that are relatively higher or lower than other exposure levels.

25. A machine readable medium as defined in claim 19 having instructions stored thereon that, when executed, cause the machine to categorize subsets of the plurality of media boards based on at least one of site type or geographic area.

26. A machine readable medium as defined in claim 25, wherein the site type specifies a type of media board comprising at least one of a billboard type, a mural type, a store facia type, or a bus shelter type.

27. A machine readable medium as defined in claim 19 having instructions stored thereon that, when executed, cause the machine to adjust a first one of the exposure levels corresponding to a first one of the media boards based on a second one of the exposure levels corresponding to a second one of the media boards if the first and second media boards are at least one of a same board type or located along a same path of travel.
